(19) United States
(12) Patent Application Publication
(10) Pub. No.: US 2018/0051625 A1
(43) Pub. Date: Feb. 22, 2018

(54) SWITCH VALVE AND CONNECTING ROD WITH SWITCH VALVE

(71) Applicant: ECO Holding 1 GmbH, Marktheidenfeld (DE)

(72) Inventors: Christian Jung, Eisenhuettenstadt (DE); Sebastian Wissler, Munich (DE); Dietmar Schulze, Muenzenberg (DE)

(21) Appl. No.: 15/652,046

(22) Filed: Jul. 17, 2017

(30) Foreign Application Priority Data
Aug. 16, 2016 (DE) DE102016115192.0
Apr. 10, 2017 (DE) DE102017107694.8

(51) Int. Cl. F02B 75/04

(52) U.S. Cl. CPC F02B 75/045; F16K 15/026

(57) ABSTRACT

A switch valve for controlling a flow of a hydraulic fluid in a connecting rod for a variable compression internal combustion engine, the switch valve including a capture element; a valve housing including a first operating connection and a second operating connection and a supply connection that is loadable with a hydraulic pressure of the hydraulic fluid, wherein the capture element is arranged in the valve housing and optionally movable into a first switching position or a second switching position, wherein the first operating connection is connected with the supply connection or a tank in the first switching position, wherein the second operating connection is connected with the supply connection or the tank in the second switching position, wherein at least one check valve is provided which facilitates a flow of the hydraulic fluid from the second operating connection to the first operating connection.

### RELATED APPLICATIONS

This application claims priority from German Patent Applications

DE10 2016 115 192.0 filed on Aug. 16, 2016 and
DE10 2017 107 694.8 filed on Apr. 10, 2017, both of which are incorporated in their entirety by this reference.

### FIELD OF THE INVENTION

The invention relates to a switch valve, in particular for controlling a hydraulic fluid flow of a connecting rod for an internal combustion engine with variable compression with an eccentrical element adjustment arrangement for adjusting an effective connecting rod length.

### BACKGROUND OF THE INVENTION

In internal combustion engines a high compression ratio has a positive effect upon efficiency of the internal combustion engine. The compression ratio is typically defined as a ratio of the entire cylinder space before the compression to the remaining cylinder space after the compression. In internal combustion engines with external ignition in particular gasoline engines which have a fixed compression ratio the compression ratio, however, may only be selected at a level so that so called “knocking” of the internal combustion engine is prevented under full load operations. However the compression ratio could be selected with higher values for much more prevalent partial load operations of the internal combustion engine thus for a lower filling of the cylinder without knocking occurring. The important partial load operations of an internal combustion engine can be improved when the compression ratio is variably adjustable. In order to adjust the compression ratio for example systems with variable connecting rod length are known.

A switch valve for a connecting rod for an internal combustion with variable compression with an eccentrical element adjustment arrangement for adjusting an effective connecting rod length is known for example from DE 10 2012 112 461 A1.

### BRIEF SUMMARY OF THE INVENTION

It is object of the invention to provide a switch valve and a connecting rod with a switch valve which prevent unintentional changing of the position of the connecting rod.

The object is achieved by a switch valve for controlling a flow of a hydraulic fluid in a connecting rod for a variable compression internal combustion engine with an eccentrical element adjustment arrangement for adjusting an effective connecting rod length, the switch valve including a capture element; a valve housing including a first operating connection and a second operating connection and a supply connection that is loadable with a hydraulic pressure of the hydraulic fluid, wherein the capture element is arranged in the valve housing and optionally movable into a first switching position or a second switching position, wherein the first operating connection is connected with the supply connection or a tank in the first switching position, wherein the second operating connection is connected with the supply connection or the tank in the second switching position, wherein at least one check valve is provided which facilitates a flow of the hydraulic fluid from the second operating connection to the first operating connection.

The object is also achieved by a connecting rod for an internal combustion engine with variable compression, the connecting rod including an eccentrical element adjustment arrangement for adjusting an effective connecting rod length wherein the eccentrical element adjustment arrangement includes a first cylinder and a second cylinder, a respective inlet for feeding hydraulic fluid through a supply conduit into the first cylinder and the second cylinder, a respective outlet for draining hydraulic fluid from the first cylinder and the second cylinder, an eccentrical element cooperating with an eccentrical element lever, a first piston and a second piston respectively supported in a displaceable manner in the first cylinder and in the second cylinder, wherein a first eccentrical element rod of the eccentrical element adjustment arrangement is supported at the first piston and engages the eccentrical element lever, wherein a second eccentrical element rod of the eccentrical element adjustment arrangement is supported at the second piston and engages the eccentrical element lever, wherein at least one respective check valve is associated with the first cylinder and the second cylinder, wherein the at least one respective check valve facilitates feeding the hydraulic fluid through an inlet to the first cylinder and the second cylinder and prevents an emptying of the first cylinder and the second cylinder, wherein an adjustment travel of the eccentrical element adjustment arrangement is adjustable by the switch valve recited supra.

Advantageously embodiments an advantages of the invention can be derived from the additional claims, the description and the drawing figures.

A switch valve for controlling a hydraulic fluid flow of a connecting rod for an internal combustion engine with variable compression with an eccentrical element adjustment arrangement for adjusting an effective connecting rod length is proposed, the switch valve comprising a capture element and a valve housing which includes a first operating connection and a second operating connection and a supply connection that is loadable with a hydraulic pressure of the hydraulic fluid. The capture element is arranged in the valve housing and optionally movable into a first switching position or into a second switching position wherein the first operating connection is connected with the supply connection or a tank in the first switching position and the second operating connection is connected with the supply connection or the tank in the second switching position. According to the invention a check valve is provided which facilitates a hydraulic fluid flow from the second operating connection to the first operating connection.

At the first operating connection of the switch valve according to the invention a first cylinder can be connected as a hydraulic support chamber of an adjustable connecting rod, for example the cylinder on a mass force side (MKS) of the connecting rod and at the second operating connection a second cylinder can be connected as a hydraulic support chamber, for example the cylinder on a gas force side (GKS) of the connecting rod. The respective chambers are typically designated as MKS chamber or GKS chamber.

As will be described infra a check valve is provided in the switch valve wherein the check valve facilitates an emptying of the associated cylinder and feeding the hydraulic fluid into the other cylinder. The check valve can be advantageously arranged directly in the capture element of the switch valve.

The capture element is moveably arranged in a bore hole of the valve housing and optionally displaceable into the first switching position or the second switching position, wherein a drain of the first cylinder is connected with the check valve in the first switching position and a drain of the second cylinder is connected with the switch valve in the second switching position. Thus hydraulic fluid from the drain of the second cylinder can be conducted in the second switching position of the check valve according to the invention from the second operating connection of the switch valve through the check valve to the first operating connection so that it can be used for filling the first cylinder. Thus it is advantageously prevented that the hydraulic fluid first has to be returned through the supply connection of the switch valve which leads into the supply connection to a tank and only then can be fed to the first cylinder through the supply connection from the tank.

Thus, in the second switching position of the switch valve hydraulic fluid for example from the GKS chamber of the connecting rod can run through the second operating connection and further through the opening check valve into an opening of the capture element and can be fed to the MKS chamber of the connecting rod through the first operating connection. However, the check valve blocks in the direction of the GKS chamber so that the MKS chamber is blocked against emptying. This way quick filling of the MKS chamber is facilitated.

Simultaneously superfluous hydraulic fluid can run through the supply connection in a direction towards the supply conduit in a throttled manner when the volume of the GKS chamber is greater than the volume of the MKS chamber.

Feeding hydraulic fluid to the MKS chamber through the first operating connection of the switch valve can then be advantageously performed in a throttled manner in order to facilitate a stable function of the eccentrical element adjustment arrangement. Throttling the first operating connection can also be advantageously performed downstream of the switch valve.

However, in the first switching position of the switch valve the check valve blocks in a direction towards the GKS chamber so that hydraulic fluid from the MKS chamber cannot be run directly into the GKS chamber of the connecting rod but is first run in a throttled manner into the supply connection of the check valve and thus into the supply connection of the connecting rod. The GKS chamber can then only be filled through a replenishing of hydraulic fluid through the supply conduit from the tank.

The first switching position for this connection of the check valve with the eccentrical element adjustment arrangement corresponds to a position with high compression (ε_{high}) of the connecting rod, whereas the second switching position corresponds to a position with low compression (ε_{low}) of the connecting rod.

According to an advantageous embodiment the check valve can be provided in the capture element. This way an advantageous connection of the check valve with the operating connections of the switch valve can be provided since the connections of the check valve are adjusted by the capture element. This yields a very compact configuration of the check valve which reduces space requirement of the check valve in a connecting rod.

Alternatively, however, it is also possible to arrange the check valve in the valve housing of the switch valve. This way the capture element can be advantageously configured compact.

According to an advantageous embodiment an opening direction of the check valve can be arranged in a longitudinal direction of the capture element. An orientation of this type can advantageously influence the function of the check valve during operations since the direction of opening and closing the check valve can be supported by the axial movement of the capture element. By the same token a jamming of the check valve through the frequent movements of the capture element is rather unlikely.

According to an advantageous embodiment the check valve can include a cover attached in a capture element and a preloaded closure element, in particular a closure element that is spring loaded by a spring. The closure element can be for example a ball or a slide which is pressed into a valve seat by the spring and can be opened in an opposite direction by a pressure from the hydraulic fluid. The check valve can thus be advantageously mounted in a bore hole of the capture element and can be safely fixated in a preloaded position of the closure element with the cover forming a closure towards the capture element.

According to an advantageously embodiment the hydraulic flow to the supply connection can be provided through a throttling location. In particular when there is high pressure in a cylinder it is advantageous when the hydraulic fluid can drain in a throttled manner through the supply connection. Thus, the volume of the cylinder is not emptied quickly. In particular a substantial volume of the hydraulic fluid can flow from the second operating connection through the check valve to the first operating connection and can thus fill the connected first cylinder as quickly as possible.

According to an advantageous embodiment the capture element can be interlockable by a locking element loaded by a spring element in at least one locking groove. This way the two switching positions of the switch valve can be implemented in an advantageous manner. Through the interlocking element a reliable function of the capture element can be provided. Also this way a simple configuration of the switch valve can be provided which facilitates mounting the switch valve.

According to an advantageous embodiment the interlocking element can be arranged in the valve housing and the at least one interlocking groove can be arranged in the capture element. This simplifies assembly of the capture element in the valve housing since the spring loaded capture element can be arranged in the valve housing first and the capture element can then be pushed with the interlocking groove over the interlocking element. Thus, the switch valve can be mounted in a simple manner.

According an advantageous embodiment a movement path of the capture element can be limitable by a locking pin that is supported in a groove. The locking pin represents a simple option to limit the axial movement of the capture element in order to implement both switching positions of the switch valve. This way also the capture element can be mounted in the valve housing first and thereafter the locking pin can be inserted into the groove and fixated which simplifies assembly of the switch valve.

According to an advantageous embodiment the locking pin can be arranged in the valve housing and the groove can be arranged in the capture element. In this embodiment the locking pin can also be inserted into the valve housing and fixated after mounting the capture element. The axial movement of the capture element can thus be limited in a suitable manner.

According to another aspect of the invention a connecting rod for an internal combustion engine with variable compression is proposed, the connecting rod comprising an eccentrical element adjustment arrangement for adjusting an effective connecting rod length, wherein the eccentrical element adjustment arrangement includes two cylinders and wherein respectively an infeed for feeding hydraulic fluid into the cylinders is provided through a supply conduit as well as a drain is provided for draining hydraulic fluid from the cylinders. The eccentrical element adjustment arrangement includes an eccentrical element cooperating with an eccentrical element lever, two pistons which are respectively supported in a displaceable manner in the cylinder and in which the eccentrical element rods engaging the eccentrical element lever of the eccentrical element adjustment arrangement are supported. The cylinders are respectively associated with at least one check valve which facilitates a feeding hydraulic fluid through the infeed to the cylinders and prevents an emptying of the cylinders. Thus an adjustment path of the eccentrical element adjustment arrangement is adjustable by a switch valve.

The inlet and the outlet of a cylinder can also be respectively configured as a common hydraulic conduit.

Advantageously the switch valve can include a capture element and a valve housing which includes a first operating connection and a second operating connection and a supply connection that is loadable by a hydraulic pressure of the hydraulic fluid. The capture element is arranged in the valve housing and optionally displaceable into a first shifting portion or into a second shifting position wherein the drain of the first cylinder is connected with the supply conduit in the first shifting position and the drain of the second cylinder is connected with the supply conduit in the second shifting position. Thus, the switch valve includes at least one check valve which facilitates an emptying of the second cylinder and a feeding the hydraulic fluid into the first cylinder.

At the first operating connection of the switch valve according to the invention a first cylinder can be connected as a hydraulic support chamber of the adjustable connecting rod, for example the cylinder on a mass force side (MKS) of the connecting rod and at the second operating connection the second cylinder can be connected as a hydraulic support chamber, for example the cylinder on the gas force side (GKS) of the connecting rod.

The switch valve according to the invention facilitates safe filling of the MKS chamber directly from the volume of the GKS chamber. It is also prevented that the connecting rod changes its position from a low compression position unintentionally into a high compression position under certain operating conditions. In particular at high speeds of the internal combustion engine it can happen that the MKS chamber cannot be safely filled anymore from the hydraulic fluid supply conduit through a check valve upstream of the MKS chamber when the internal combustion engine is coasting since the mass and pressure forces become more and more unfavorable for opening the check valve when engine speeds increase. The MKS chamber can empty through leakage but cannot be filled anymore since the check valve does not open. A check valve in front of the GKS chamber is not subject to these conditions so that the GKS chamber fills slowly. Due to lacking gas forces, only mass forces are active. The GKS chamber does not empty anymore.

This situation can be circumvented by the switch valve with the integrated check valve since the MKS chamber can be filled according to the invention directly from the volume of the hydraulic fluid of the GKS chamber. Thus, the check valve prevents advantageously that the MKS chamber can empty through the check valve back into the GKS chamber.

Thus, advantageously hydraulic fluid can run in the second switching position of the check valve for example from the GKS chamber of the connecting rod through the second operating connection and further through the opening check valve into an opening of the capture element and can be fed to the MKS chamber of the connecting rod through the first operating connection. However, the check valve blocks in the direction of the GKS chamber so that the MKS chamber is secured against emptying. This way quick filling of the MKS chamber can be accomplished.

Simultaneously superfluous hydraulic fluid can drain in a throttled manner through the supply connection in a direction towards the supply conduit when the volume of the GKS chamber is greater than the volume of the MKS chamber.

The feeding of hydraulic fluid through the first operating connection of the switch valve can thus be advantageously performed in a throttled manner in order to achieve a stable function of the eccentrical element adjustment arrangement. Throttling the first operating connection can also be advantageously performed downstream of the switch valve.

In the first switching position of the switch valve, however, the check valve blocks in a direction towards the GKS chamber so that hydraulic fluid from the MKS chamber cannot be conducted directly into the GKS chamber of the connecting rod, but is first conducted into the supply connection of the check valve and thus into the supply conduit of the connecting rod in a throttled manner. The GKS chamber can then only be filled by feeding hydraulic fluid through the supply conduit from the tank.

The first switching position in this connection of the switch valve with the eccentrical element adjustment arrangement corresponds to a position with high compression, (ε_{high}) of the connecting rod whereas the second switching position corresponds to a position with low compression (ε_{low}) of the connecting rod.

According to an advantageous embodiment the check valve can be provided in the capture element. This way an advantageous connection of the check valve with the operating connections of the check valve can be provided since the connections of the check valve are adjusted by the capture element. This yields a very compact configuration of the check valve which reduces an installation space requirement of the check valve in the connecting rod.

Alternatively, however, it is also feasible to arrange the check valve in the valve housing of the switch valve. This way the capture element can be advantageously configured compact.

According to an advantageous embodiment an opening direction of the check valve can be oriented in a longitudinal direction of the capture element. This orientation can influence the function of the check valve during operations advantageously since the direction of opening and closing the check valve can be supported by the axial movement of the capture element. Thus, binding of the check valve through frequent movement of the capture element is rather unlikely.

According to an advantageous embodiment the switch valve can be arranged so that the longitudinal direction of the capture element is oriented parallel to a connecting rod eye axis of a connecting rod eye. In this arrangement the movement of the capture element is performed parallel to the connecting rod eye axis and the check valve is also oriented with its opening direction parallel to the connecting rod eye axis. Thus, the linear movement of the capture element as well as of the closure element of the check valve can be performed irrespective of the movement of the connecting rod. Thus, both elements are not exposed to additional forces through the connecting rod which would support a movement in one or another direction.

According to an advantageous embodiment the check valve can be arranged so that the longitudinal direction of the capture element is arranged at a slant angle relative to a connecting rod eye axis of a connecting rod eye. In an alternative embodiment the movement of the capture element and of the closure element of the check valve can be performed in particular perpendicular to the connecting rod eye axis. Thus, the movement of the capture element can be at least partially supported or inhibited by inertia. By the same token an opening or closing of the check valve can be at least partially supported or impeded by the inertia of the closure element as a function of the movement direction of the piston.

### BRIEF DESCRIPTION OF THE DRAWINGS

Further advantages of the invention can be derived from the subsequent drawing description. The drawing figures schematically illustrate an embodiment of the invention. The drawing figures, the description and the patent claims include numerous features in combination. A person skilled in the art will advantageously also view the features individually and combine them into useful other combinations, wherein:

FIG. 1 illustrates a switch valve according to the invention in a side view;

FIG. 2 illustrates the switch valve FIG. 1 in a side view that is rotated by 90°;

FIG. 3 illustrates the switch valve of FIG. 1 in a cross sectional view with cross sectional planes G-G, H-H;

FIG. 4 illustrates the switch valve in the longitudinal sectional view G-G of FIG. 3;

FIG. 5 illustrates a switch valve in the longitudinal sectional view H-H of FIG. 3;

FIG. 6 illustrates the switch valve of FIG. 1 in a second switching position in a side view with illustrated sectional planes A-A, B-B, C-C;

FIG. 7 illustrates the switch valve in the longitudinal sectional view A-A of FIG. 6;

FIG. 8 illustrates the switch valve in the cross sectional view B-B of FIG. 6;

FIG. 9 illustrates the switch valve in the cross sectional view C-C in FIG. 6;

FIG. 10 illustrates the switch valve of FIG. 1 in a first switching position in a side view with designated sectional planes A-A, D-D;

FIG. 11 illustrates the switch valve in the longitudinal sectional view A-A of FIG. 10 with an illustrated sectional plane F-F;

FIG. 12 illustrates the switch valve in the cross section D-D in FIG. 10;

FIG. 13 illustrates the switch valve in the first switching position in another side view with a designated sectional plane E-E;

FIG. 14 illustrates the switch valve in the cross section E-E of FIG. 13;

FIG. 15 illustrates the switch valve in the cross section F-F of FIG. 11;

FIG. 16 illustrates a connecting rod according to the invention in a front view; and

FIG. 17 illustrates a hydraulic diagram of the connecting rod according to the invention.

### DETAILED DESCRIPTION OF THE INVENTION

In the figures identical or like components are configured with identical reference numerals. The figures merely illustrate embodiments and do not limit the spirit and scope of the invention.

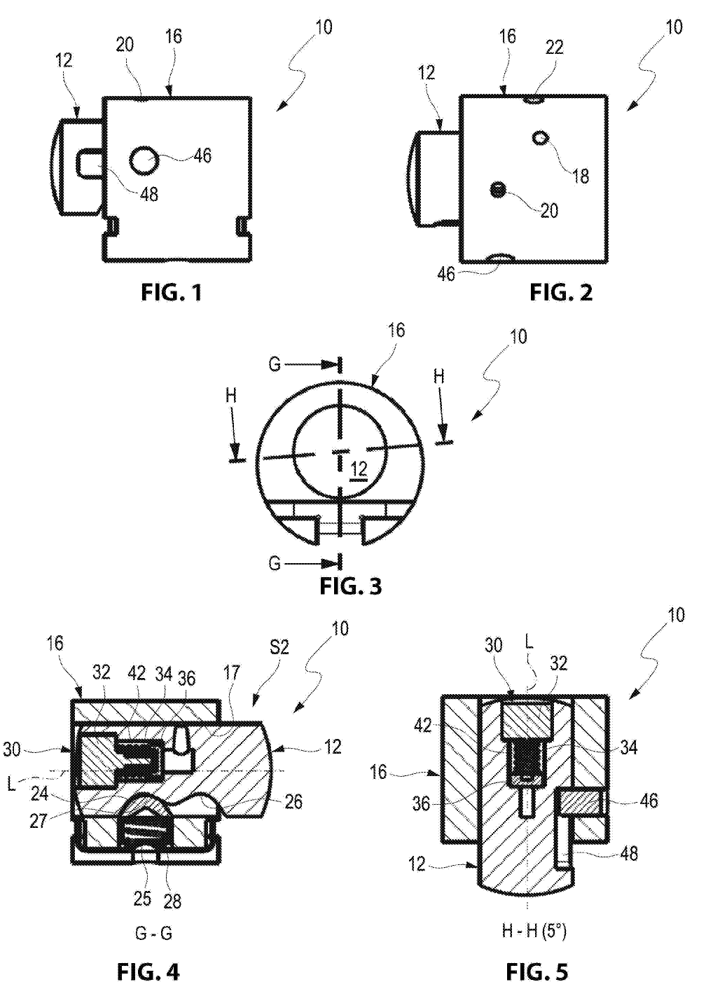

FIG. 1 illustrates a switch valve 10 according to the invention in a side view, whereas FIG. 2 illustrates the switch valve 10 in a side view that is rotated by 90°. FIG. 3 illustrates the switch valve 10 in a cross sectional view with illustrated sectional planes G-G, H-H. The longitudinal sectional views G-G and H-H are illustrated in FIG. 4 and FIG. 5.

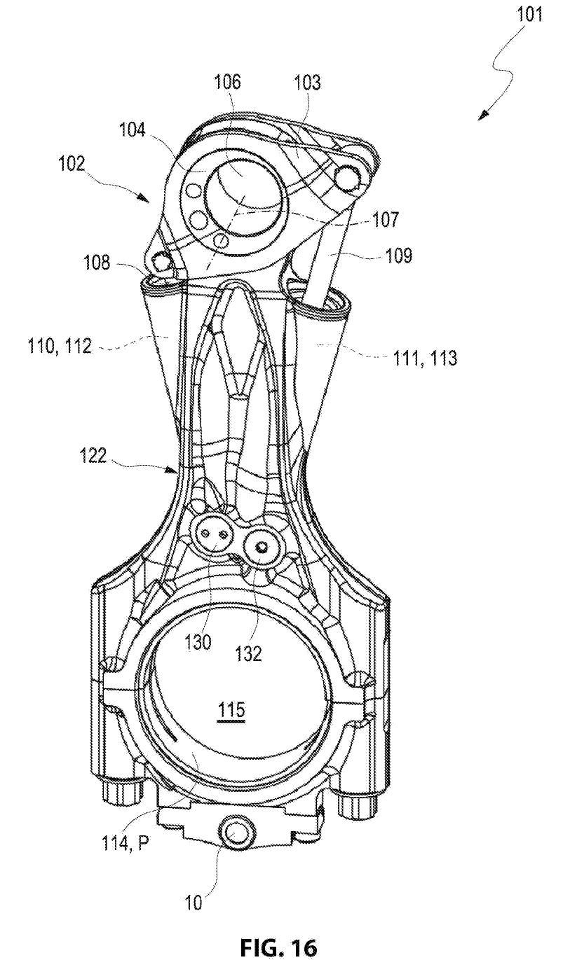

The switch valve 10 is configured in particular for controlling a hydraulic fluid flow of a connecting rod 101 for an internal combustion engine with variable compression with an eccentrical element adjustment arrangement for adjusting an effective connecting rod length as illustrated in FIG. 16.

The switch valve 10 includes a capture element 12 in a valve housing 16 which includes a first operating connection 18 and a second operating connection 20 and a supply connection 22 that is loadable with a hydraulic pressure of the hydraulic fluid. The operating connections 18, 20 and the supply connection 22 are illustrated in FIG. 2 on an outside of the valve housing 16′.

The capture element 12 is arranged in a displaceable manner in a bore hole 17 of the valve housing 16 and optionally movable into a first switching position S1 or a second switching position S2, wherein the first operating connection 18 is connected with the supply connection 22 or alternatively with a tank like e.g. the crank case in the first switching position S1 and the second operating connection 20 is connected with the supply connection 22 or alternatively with a tank like e.g. the crank case in the second switching position S2.

FIG. 3 illustrates the capture element 12 in its support in the valve housing 16 in a cross sectional view.

As illustrated in FIG. 4 the capture element 12 is arrested by an interlocking element 24 and a spring element 25 in one of the two switching positions S1, S2, wherein the switching element 24 and the spring element 25 cooperate with interlocking grooves 26, 27 configured in the capture element 12. The interlocking element 24 is arranged in the valve housing 16 and the interlocking grooves 26, 27 are arranged in the capture element 12. It is evident that the interlocking element 24 is preloaded by the spring element 25 in a direction towards the capture element 12. The interlocking element 24 and the spring element 25 are fixated in the valve housing 16 by a spring retainer 28 configured as a clip. Overall two interlocking grooves 26, 27 are provided so that a respective interlocking groove 26, 27 is provided for receiving the interlocking element 24 for the first switching position S1 and the second switching position S2 of the switch valve 10. In FIG. 4 the interlocking element 24 is interlocked in the interlocking groove 27, the capture element 12 is thus arrested in the second switching position S2.

As evident from FIG. 5 a displacement travel of the capture element 12 can be limited by an interlocking pin 46 that is supported in a groove 48. The interlocking pin 46 is thus arranged in the valve housing 16 and the groove 48 is arranged in the capture element 12. Alternatively, however, also the interlocking pin 46 could be arranged in the capture element 12 and the groove 48 could be arranged in the valve housing 16.

According to the invention a check valve 30 is provided in the capture element 12 wherein the check valve facilitates a hydraulic fluid flow from the second operating connection 20 to the first operating connection 18. The check valve 30, however, could be alternatively arranged directly in the valve housing 16.

As evident from the longitudinal sectional views in FIGS. 4 and 5 the check valve 30 includes a cover 32 attached in a capture element 12 and a closure element 36 configured as a closure plate and spring loaded by a spring 34. A ball can also be used for the closure element 36. Thus, an opening direction of the check valve 30 is oriented in a longitudinal direction L of the capture element 12.

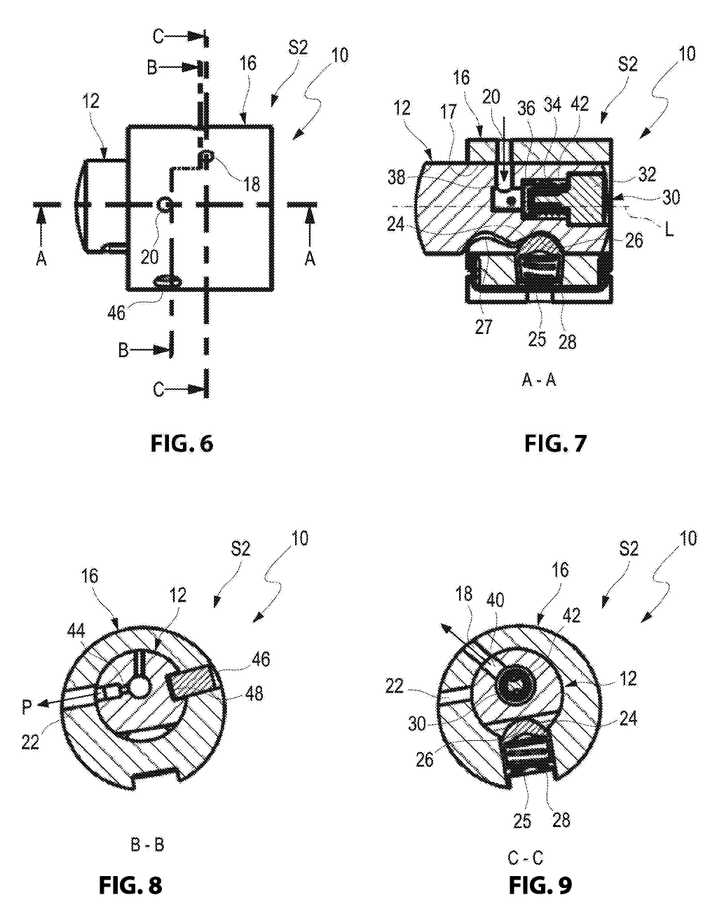

FIG. 6 illustrates the switch valve 10 of FIG. 1 in a second switching position S2 in a side view with designated sectional planes A-A, B-B, C-C. The longitudinal sectional view A-A and the cross sections B-B and C-C in FIG. 6 are respectively illustrated in FIGS. 7, 8 and 9. The switching position S2 thus corresponds for example to a position with low compression (ε_{low}) when the switch valve 10 is used in a connecting rod.

As indicated by arrows which symbolize the hydraulic flow in FIGS. 7-9 the hydraulic fluid can drain from a connected cylinder by bore holes in the capture element 12 and in the valve housing 16 through the second operating connection 20 and the bore hole 38 and further through the opening check valve 30 into an opening 42 of the capture element 12 (c.f. FIG. 7). The hydraulic fluid can then be provided to another cylinder through a bore hole 40 in the capture element 12 and through the first operating connection 18 (c.f. FIG. 9). Simultaneously the hydraulic fluid runs through the supply connection 22 in a direction towards the supply conduit P through a throttling location 44 in a throttled manner (c.f. FIG. 8). The throttling location 44 is thus provided in the capture element 12.

The check valve 30 blocks in a reverse flow direction so that a connected cylinder is blocked against emptying.

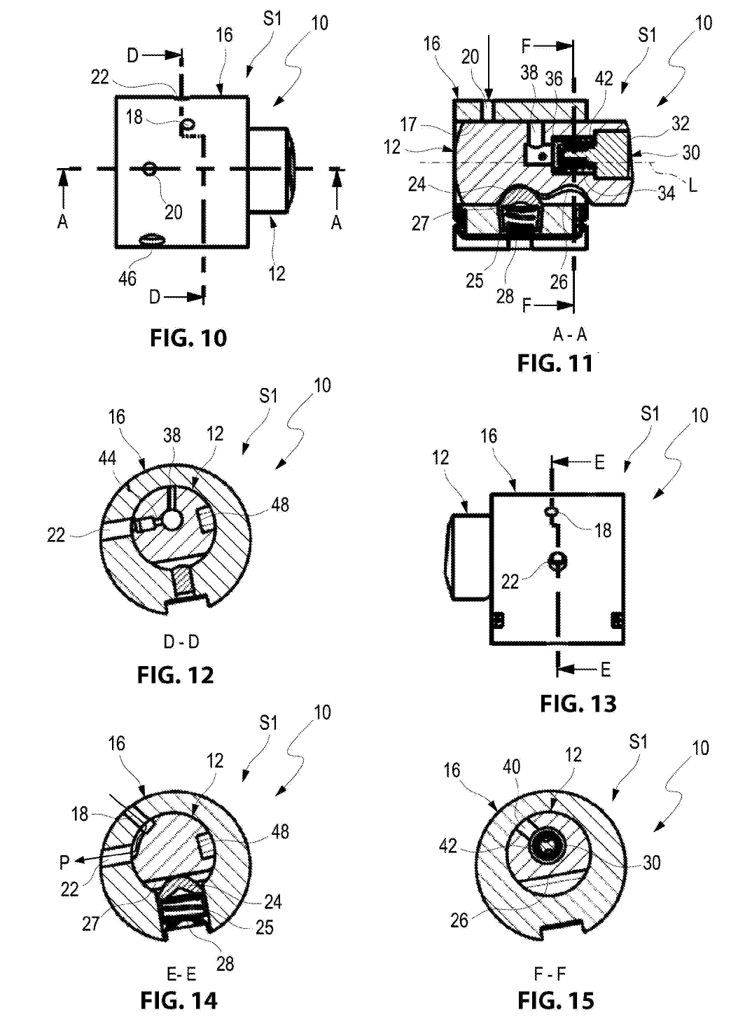

FIG. 10 illustrates the switch valve 10 in a first switching position S1 in a side view with illustrated sectional planes A-A, D-D. The longitudinal sectional view A-A designated in FIG. 10 by the indicated sectional plane F-F is illustrated in FIG. 11, whereas the sectional view D-D indicated in FIG. 10 is illustrated in FIG. 12. FIG. 13 illustrates the switch valve 10 in the first switching position S1 in another side view with indicated sectional plane E-E, whereas the cross section E-E is illustrated in FIG. 14 and the cross section F-F is illustrated in FIG. 15. Thus, the switching position S1 corresponds for example to a position with high compression (ε_{high}) when the switch valve 10 is inserted in a connecting rod.

As illustrated by arrows which symbolize the hydraulic flow in FIGS. 11 and 14 the drain from the GKS chamber through the second operating connection 20 is blocked. The MKS chamber, however, can drain through the first operating connection 18 and the supply connection 22 in a direction towards the supply conduit P.

The check valve 30 is not required in this switching position S1 so that all bore holes 38 (FIG. 11, 12), 40 (FIG. 15) in the capture element 12 which are associated with the check valve 30 are blocked.

FIG. 16 illustrates a connecting rod 100 according to the invention for an internal combustion engine with variable compression in a front view. The connecting rod 100 includes an eccentrical element adjustment arrangement 102 which is used for adjusting an effective rod length.

The eccentrical element adjustment arrangement 102 includes two cylinders 110, 111. An invisible inlet for providing hydraulic fluid into the cylinders 110, 111 through a supply conduit P as well as a non-illustrated drain for draining the hydraulic fluid from the cylinders 110, 111 are provided. The eccentrical element adjustment arrangement 102 includes an eccentrical element 104 cooperating with an eccentrical element lever 103, two pistons 112, 113 which are respectively supported in the cylinders 110, 111 in a displaceable manner in which eccentrical element rods 108, 109 engaging the eccentrical element lever 103 of the eccentrical element adjustment arrangement 102 are supported. The eccentrical element 104 is arranged with its connecting rod eye axis 107 in the connecting rod eye 106.

A respective check valve 130, 132 is associated with the cylinders 110, 111, wherein the check valve facilitates feeding hydraulic fluid through the infeed to the cylinders 110, 111 and prevents an emptying of the cylinders 110, 111. An adjustment travel of the eccentrical element adjustment arrangement 102 is adjustable by the switch valve 10. An inlet and an outlet of a cylinder can be respectively configured as a common hydraulic conduit.

A rotation of the adjustable eccentrical element adjustment arrangement 102 is initiated by an impact of mass and load forces of the internal combustion engine which impact the eccentrical element adjustment arrangement 102 during an operating stroke of the internal combustion engine. During an operating stroke the effective directions of forces impacting the eccentrical element adjustment arrangement 102 change continuously.

The rotation movement or adjustment movement is supported by the pistons 112, 113 that are loaded with the hydraulic fluid in particular with engine oil and that are integrated in the piston and not visible or the pistons 112, 113 prevent a reset of the eccentrical element adjustment arrangement 102 due to varying force effective directions of the forces impacting the eccentrical element adjustment arrangement 102.

The pistons 112, 113 are operatively connected by eccentrical element adjustment rods 108, 109 on both sides with the eccentrical element lever 103. The pistons 112, 113 are movably arranged in the cylinders 110, 111 and loaded with the hydraulic fluid from inlets in the connecting rod 100 from a crank bearing eye 115 or another pressure source through the check valves 130, 132. The check valves prevent a flow back of the hydraulic fluid from the cylinders 110, 111 back into the inlets and into a bearing shell 114 of the bearing eye 115 and facilitate a suction of hydraulic fluid into the cylinders 110, 111. The cylinders 110, 111 are connected with drains which cooperate with the check valve 10 described supra.

In a first switching position S1 of the switch valve 10 the drain of the first cylinder 110 is connected with the supply connection P and in a second switching position S2 the drain of the second cylinder 111 is connected with the supply connection P, wherein at least one check valve 30 is provided in the switch valve 10 which facilitates emptying the associated cylinder 111 and feeding the hydraulic fluid into the other cylinder 110. The switch valve 10 is advantageously arranged so that the longitudinal direction L of the capture element 12 is oriented parallel to the connecting rod eye axis 107 of the connecting rod eye 106.

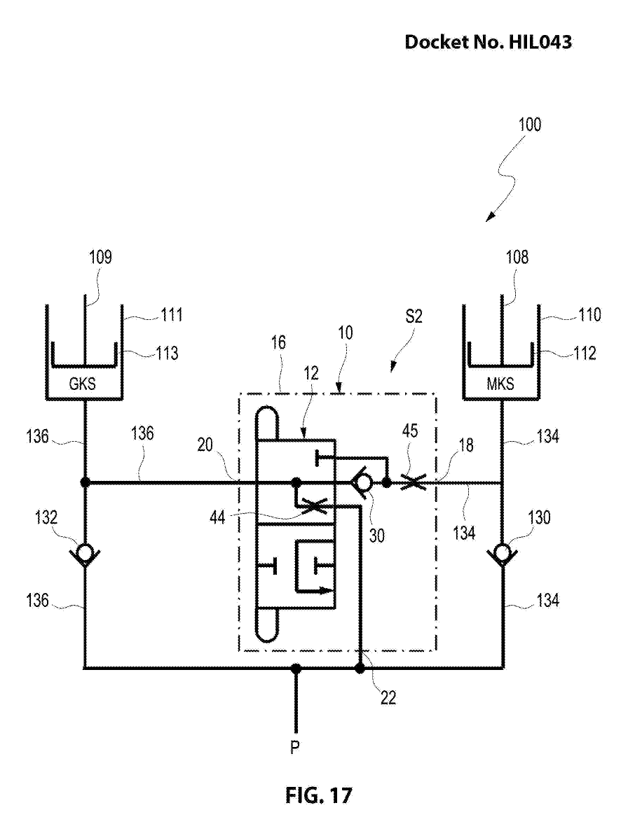

Thus, FIG. 17 illustrates a hydraulic diagram of the connecting rod 100 according to the invention.

Thus, the connecting rod 100 with the pistons 112, 113 supported in the cylinders 110, 111 is only schematically indicated.

The switch valve 10 includes the capture element 12 and the valve housing 16 which includes the first operating connection 18 and the second operating connection 20 and the supply connection 22 which is loadable with a hydraulic pressure of the hydraulic fluid.

The first cylinder 110 is connected through a hydraulic conduit 134 which is configured as a combined inlet and outlet with the first operating connection 18 of the switch valve 10 and through a check valve 130 with the supply connection P. The second cylinder 111 is connected through a hydraulic conduit 136 which is configured as a combined inlet and outlet with the second operating connection 20 of the switch valve 10 and through a check valve 132 with the supply connection P. Both cylinders 110, 111 can be supplied with hydraulic fluid through the check valves 130, 132 from the supply conduit P. A reverse flow into the supply conduit P is only possible through the switch valve 10 since the check valves 130, 132 block in this direction.

The capture element 12 is arranged in the valve housing 16 and optionally displaceable into a second switching position S2 (illustrated in FIG. 17) or into a first switching position S1, wherein the second outlet is connected with the supply connection P through the hydraulic conduit 136 in the second switching position S2 and the first outlet is connected through the hydraulic conduit 134 with the supply connection P in the first switching position S1. A check valve 30 is provided in the switch valve 10 wherein the check valve 30 facilitates emptying the associated cylinder 111 and feeding the hydraulic fluid into the other cylinder 110 in the second switching position S2.

As illustrated in FIG. 17 hydraulic fluid can flow from the second cylinder 111 through the hydraulic conduit 136 into the second operating connection 20 of the check valve 10. In the second switching position S2 which corresponds to the low compression position (ε_{low}) of the connecting rod 100. In the switch valve 10 the hydraulic fluid flows further through the capture element 12 and the check valve 30 from the first operating connection 18 into the hydraulic conduit 134 and can thus fill the first cylinder 110. The inflow into the first cylinder 110 is thus performed through the throttling location 45 in order to make the hydraulic flow more uniform. A portion of the hydraulic fluid from the second cylinder 111 can flow through the throttling location 44 to the supply connection 22 and from there into the supply conduit P. This is advantageous in particular when the volume of the second cylinder 111 is greater than the volume of the first cylinder 110. Due to the position of the check valves 30 and 130 the hydraulic fluid cannot flow back anymore from the first cylinder 110.

As evident from the hydraulic diagram of the capture element 12 hydraulic fluid can only be fed into the second cylinder 111 through the check valve 132 from the supply conduit P in the first switching position S1 when the capture element 12 is pushed upward in the hydraulic diagram in FIG. 17 wherein the switching position S1 corresponds to the high compression position (ε_{high}) since the second operating connection 20 is then blocked by the capture element 12. Hydraulic fluid from the first cylinder 110, however, can be run from the hydraulic conduit 134 into the first operating connection 18 through the throttling location 45 and through the capture element 12 from the supply connection 22 into the supply conduit P so that the first cylinder 110 can be emptied.

What is claimed is:

1. A switch valve for controlling a flow of a hydraulic fluid in a connecting rod for a variable compression internal combustion engine with an eccentrical element adjustment arrangement for adjusting an effective connecting rod length, the switch valve comprising:
a capture element;
a valve housing including a first operating connection and a second operating connection and a supply connection that is loadable with a hydraulic pressure of the hydraulic fluid,
wherein the capture element is arranged in the valve housing and movable into a first switching position or a second switching position,
wherein the first operating connection is connected with the supply connection or a tank in the first switching position,
wherein the second operating connection is connected with the supply connection or the tank in the second switching position,
wherein at least one check valve is provided which facilitates a flow of the hydraulic fluid from the second operating connection to the first operating connection.

2. The switch valve according to claim 1, wherein the check valve is provided in the capture element.

3. The switch valve according to claim 2, wherein an opening direction of the check valve is oriented in a longitudinal direction of the capture element.

4. The switch valve according to claim 2, wherein the at least one check valve includes a cover that is attached in the capture element and a preloaded closure element that is preloaded by a spring.

5. The switch valve according to claim 1, wherein a hydraulic fluid flow to the supply connection is provided through a throttling location.

6. The switch valve according to claim 1, wherein the capture element is interlockable in at least one interlocking groove by an interlocking element that is loaded by a spring element.

7. The switch valve according to claim 6, wherein the interlocking element is arranged in the valve housing and the at least one interlocking groove is arranged in the capture element.

8. The switch valve according to claim 1, wherein a displacement travel of the capture element is limitable by an interlocking pin that is supported in a groove.

9. The switch valve according to claim 8, wherein the interlocking pin is arranged in the valve housing and the groove is arranged in the capture element.

10. A connecting rod for an internal combustion engine with variable compression, the connecting rod comprising:
an eccentrical element adjustment arrangement for adjusting an effective connecting rod length wherein the eccentrical element adjustment arrangement includes
a first cylinder and a second cylinder,
a respective inlet for feeding hydraulic fluid through a supply conduit into the first cylinder and the second cylinder,
a respective outlet for draining hydraulic fluid from the first cylinder and the second cylinder,
an eccentrical element cooperating with an eccentrical element lever,
a first piston and a second piston respectively supported in a displaceable manner in the first cylinder and in the second cylinder,
wherein a first eccentrical element rod of the eccentrical element adjustment arrangement is supported at the first piston and engages the eccentrical element lever,
wherein a second eccentrical element rod of the eccentrical element adjustment arrangement is supported at the second piston and engages the eccentrical element lever,
wherein at least one respective check valve is associated with the first cylinder and the second cylinder,
wherein the at least one respective check valve facilitates feeding the hydraulic fluid through an inlet to the first cylinder and the second cylinder and prevents an emptying of the first cylinder and the second cylinder,
wherein an adjustment travel of the eccentrical element adjustment arrangement is adjustable by the switch valve according to claim 1.

11. The connecting rod according to claim 10,
wherein the switch valve includes the capture element and the valve housing which includes the first operating connection and the second operating connection and the supply connection that is loadable with a hydraulic pressure of the hydraulic fluid,
wherein the capture element is arranged in the valve housing and movable into the first switching position or a second switching position,
wherein a drain of the first cylinder is connected with a supply conduit in the first switching position and a drain of the second cylinder is connected with the supply conduit in the second switching position,
wherein the at least one check valve is provided in the switch valve,
wherein the at least one check valve facilitates emptying the second cylinder and feeding the hydraulic fluid from the second cylinder into the first cylinder.

12. The connecting rod according to claim 11, wherein the check valve is provided in the capture element.

13. The connecting rod according to claim 11, wherein an opening direction of the check valve is oriented in a longitudinal direction of the capture element.

14. The connecting rod according to claim 11, wherein the switch valve is arranged so that a longitudinal direction of the capture element is oriented parallel to a connecting rod eye axis of a connecting rod eye.

15. The connecting rod according to claim 11, wherein the switch valve is arranged so that a longitudinal direction of the capture element is arranged at a slant angle to a connecting rod eye axis of a connecting rod eye.
